(19) United States
(12) Patent Application Publication
(10) Pub. No.: US 2014/0017445 A1
(43) Pub. Date: Jan. 16, 2014

(54) REPAIR PART AND REPAIR METHOD FOR REPAIRING LONGITUDINAL ELEMENTS MADE OF A COMPOSITE MATERIAL

(71) Applicant: Airbus Operations, S.L., Madrid (ES)

(72) Inventors: Alberto Balsa Gonzalez, Getafe Madrid (ES); Jose Javier Almendros Gomez, Getafe Madrid (ES); Narciso Rodriguez Garcia, Getafe Madrid (ES); Maria Rocio Fernando Magarzo, Getafe Madrid (ES)

(21) Appl. No.: 13/928,047

(22) Filed: Jun. 26, 2013

(30) Foreign Application Priority Data
Jun. 29, 2012 (ES) P201231009

(51) Int. Cl. B23P 6/00; F16B 5/04

(52) U.S. Cl. CPC B23P 6/00; F16B 5/04
USPC 428/137; 29/402.09; 29/402.14

(57) ABSTRACT

The present invention relates to a repair part and to a repair method. The repair part is an elongated part made of a composite material comprising two attached portions forming an angle and holes in each portion arranged in the direction of the line joining both portions. The repair method includes: providing a fragment of a repair part, being long enough to cover the damaged area of the part to be repaired, maintaining a border for fixing the fragment of the repair part; making holes in both portions of the part to be repaired, such that the distance between the centers of consecutive repair holes is the same as the distance between the centers of the consecutive holes; and attaching the fragment of the repair part to the part to be repaired.

### CROSS-REFERENCE TO RELATED APPLICATION

This application claims the benefit of the filing date of Spanish Application Serial No. P201231009 filed Jun. 29, 2012 the disclosure of which is hereby incorporated herein by reference.

### TECHNICAL FIELD

The present invention relates to a repair part and to a repair method for repairing parts made of composite material with an angular profile.

### BACKGROUND

There are currently structures comprising parts made of high responsibility composite material, i.e., they are subjected to stress, the breaking of which compromises the stability of said structure. These parts can sustain accidental damage during the assembly or inspection process. The part is then either repaired or discarded according to the severity of said damage.

Several repair methods for repairing a part made of composite material have been known up until now: replacing fibers and attaching a patch by means of rivets or by means of adhesive.

Replacing the fibers consists of first removing the fiber matting by layers in an expanse exceeding the initially affected expanse, later placing them back on in the same orientation in which they were removed, and since the material is a composite material, applying a resin and subjecting the part to a new autoclave curing process. This entire process involves a huge investment of time and money, and the necessary materials and infrastructures are not always available.

Attaching with a patch consists of evaluating the damaged area and placing a patch having suitable dimensions on said area such that the damaged part can be attached to the patch by means of rivets or an adhesive, the loads borne by the damaged area thus being transmitted to the patch. In this method as performed in the state of the art, the repair part is contained in the plane of the damaged area, such that it is only effective for repairing planar parts.

Nevertheless, no solutions specifically aimed at repairing elongated parts made of composite material that comprise two angularly attached portions have been described up until now.

### SUMMARY

The present invention proposes a particular solution to the preceding problems by means of a repair part according to claim 1 and a method according to claim 12, for repairing a longitudinal part with an angular profile made of a composite material. The dependent claims define preferred embodiments of the invention.

Throughout the entire document, “composite material” must be understood as any type of material comprising two or more physically distinguishable and mechanically separable components, being both indissoluble with respect to one another.

In a first inventive aspect, the invention defines a repair part, characterized in that it is made of a composite material, in that it is an elongated part comprising two attached portions forming an angle comprised between 60° and 120°, the line joining both portions being substantially straight, and in that it comprises a plurality of holes in each portion arranged in the direction of the line joining both portions.

In a preferred embodiment of the invention, the angle formed by the two portions of the repair part is comprised between 85° and 95°.

In a preferred embodiment of the invention, the holes of each portion of the part are arranged in at least two rows parallel to the direction of the line joining the portions of said repair part.

In a preferred embodiment of the invention, the holes are arranged in two parallel rows such that the distance between consecutive holes of the same row is substantially identical.

In a preferred embodiment of the invention, the two parallel rows of holes are arranged such that the line joining the centers of each hole with the consecutive hole in each row and in each column forms a right-angle grid layout. In a more preferred embodiment, the distance between the centers of two consecutive holes of the same row is comprised between four and six times the diameter of the holes of the repair part. Furthermore, in another even more preferred embodiment the distance between rows is comprised between four and six times the diameter of the holes of the repair part.

In another preferred embodiment of the invention, the two parallel rows of holes are “staggered”, i.e., the position of the holes in one of the two rows corresponds with the projection of the mid-points of the position of the holes of the other row. In a more preferred embodiment, the distance between the centers of two consecutive holes of the same row is comprised between four and eight times the diameter of the holes of the repair part. Furthermore, in an even more preferred embodiment the distance between rows is comprised between two and four times the diameter of the holes of the repair part.

In a preferred embodiment of the invention, the distance between each edge of a portion of the repair part and the line joining the centers of holes of the row of holes closest to said edge of said portion of the part is comprised between two and three times the diameter of the holes of the repair part.

Advantageously, all these geometries associated with the preferred embodiments of the invention allow distributing the loads such that the correct distribution of loads from the part to be repaired to the repair part is assured according to the standards established for such attachments.

Advantageously, the structure of the part made of composite material is taken advantage of by means of the part of the invention such that the load borne by the damaged portion before the repair is transmitted by means of the repair part, such that said load is then borne by the structure supporting the damaged part.

In a second inventive aspect, a repair method is provided for repairing an elongated part to be repaired made of a composite material comprising two attached portions forming an angle comprised between 60° and 120°, the line joining both portions being substantially straight and said part to be repaired comprising a damaged area, the method the following steps comprising:
providing a fragment of a repair part according to the first inventive aspect, being long enough to cover the damaged area of the part to be repaired, maintaining a border for fixing the fragment of the repair part to the part to be repaired,
making holes in the part to be repaired on both sides of the damaged area in a longitudinal direction, such that the distance between the centers of consecutive repair holes is the same as the distance between the centers of the consecutive holes of the repair part;
making holes in the part to be repaired in a portion of said part other than in that portion in which the holes were made in the preceding step, such that the distance between the centers of consecutive repair holes is the same as the distance between the centers of the consecutive holes of the repair part; and
attaching the fragment of said repair part to the part to be repaired.

In a particular embodiment of said method, the following steps are additionally performed:
determining the length LD of the damaged area in the direction of the line joining the portions of said part to be repaired
calculating the number NC of holes necessary for covering the damaged area of the part to be repaired by means of the formula NC=LD/DC, rounding up to the next natural number, DC being the distance between two consecutive holes of the same row; and
providing a fragment of the repair part that comprises at least x holes in the same row, where x=NC+6.

In a particular embodiment of the method, the part to be repaired is attached to the repair part by means of rivets.

Advantageously, a much lower repair cost, as well as a much lower repair and commissioning time, are achieved by means of this repair method defined in the second inventive aspect than with the methods known up until now. Furthermore, the resulting distribution of loads in the structure repaired according to this method allows actions that are more secure. In the same manner, fewer instruments and qualification are necessary for making this repair. As a result, the overall repair cost is much lower.

All the features and/or steps of the methods described in this specification (including the claims, description and drawings) can be combined in any way with the exception of combinations of such mutually exclusive features.

### BRIEF DESCRIPTION OF THE DRAWINGS

These and other features and advantages of the invention will be more clearly understood from the following detailed description of a preferred embodiment, given only as an illustrative and non-limiting example in reference to the attached drawings.

FIG. 1 shows a perspective view of a repair part according to the invention.

FIG. 2 shows a perspective view of the damaged part, identifying the damaged area.

FIG. 3 shows the assembly of the repair part of FIG. 1 on the damaged part.

### DETAILED DESCRIPTION

Within the vehicle manufacturing industry using parts made of composite material, there are parts intended for bearing significant loads in a structure. When these parts sustain any damage they must be repaired so that the structure is not at any risk.

In this particular embodiment, the distance between the line joining the centers of the holes (51) of both rows is comprised between four and six times the diameter of the holes (51), and it is the same distance as the one between two consecutive holes (51) of the same row. In turn, the distance between the line joining the centers of one row and the closest edge of the portion of the part that contains said row is comprised between two and three times the diameter of the holes (51) of said repair part (1).

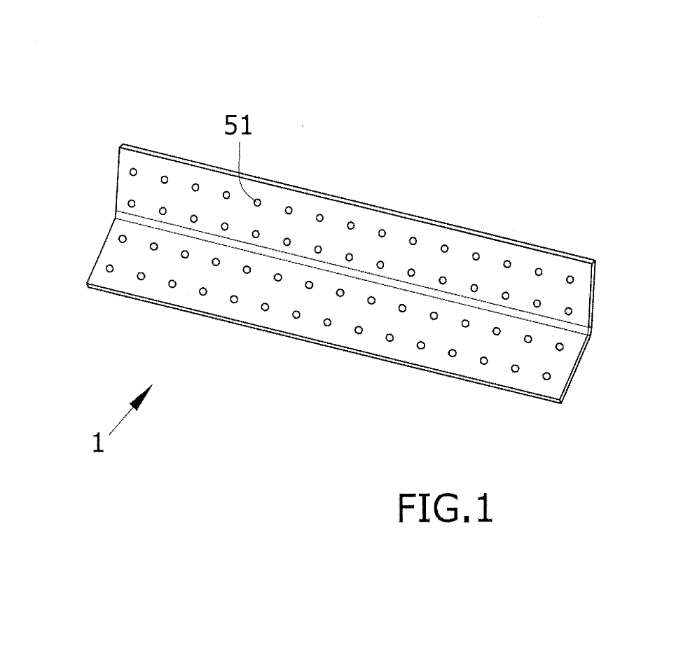

FIG. 1 shows a preferred embodiment of the repair part (1) object of the invention. This part comprises two rectangular portions attached to one another forming a substantially right angle, the line joining both portions being substantially straight. Each portion comprises a plurality of holes (51) arranged in two rows parallel to the direction of the line joining said portions.

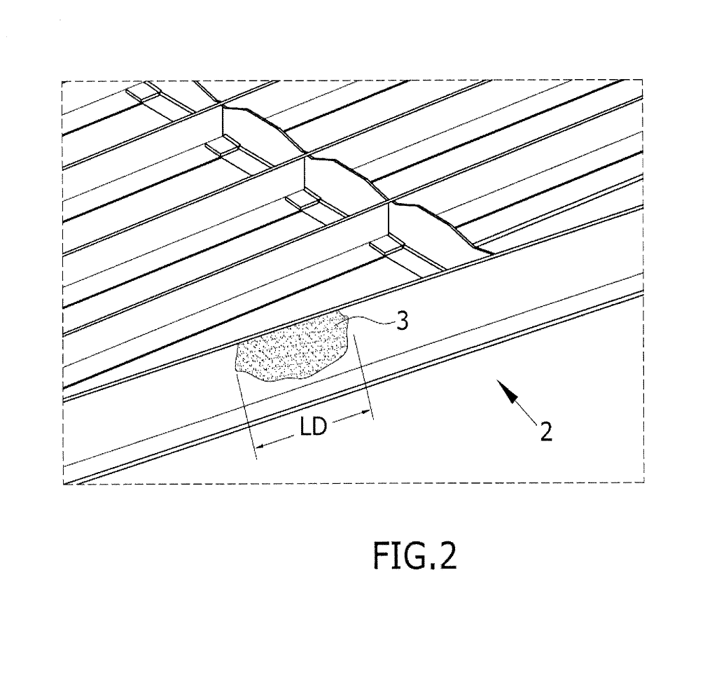

FIG. 2 shows a part to be repaired (2) with a damaged area (3) which also comprises two rectangular portions similar to those of the repair part (1). The damaged area is characterized by its length, LD, measured in the direction of the line joining the two portions of said part to be repaired (2). By means of this length LD, the number NC of columns of holes (51) occupied by said damaged area is calculated by means of the formula:

$$NC = \frac{LD}{ \begin{matrix}distance between centers of two consecutive \\ preliminary holes of the same row\end{matrix}}$$

The result is always rounded up. For example, if LD measures 102 mm and the distance between the centers of two consecutive holes (51) of the same row is 16 mm, the quotient will be 102/16=6.375→NC=7 columns.

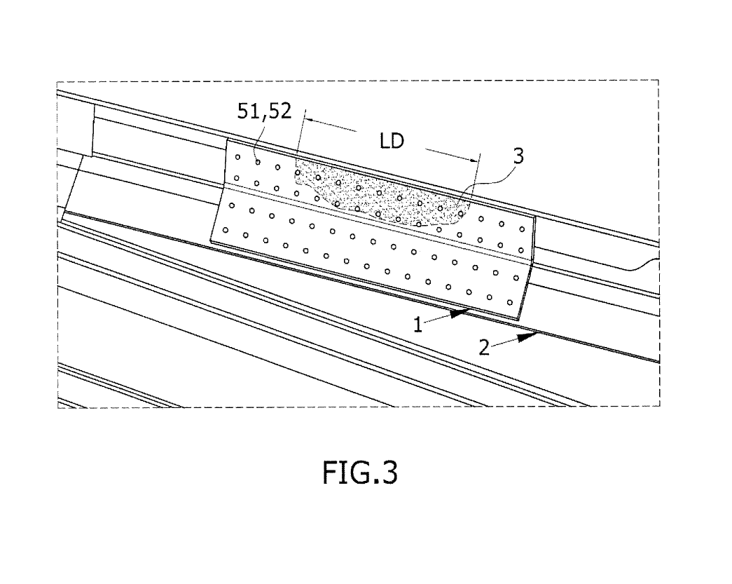

FIG. 3 shows a fragment of the repair part (1) arranged on the damaged portion of a part to be repaired (2) during the repair process. In a preferred embodiment, the repair method comprises the following steps:
Determining the length LD of the damaged area of the part to be repaired
Determining the number NC of columns that must be left on either side according to the formula

NC=LD/DC

DC being the distance between two consecutive holes (51) of the same row, and rounding NC up to the next natural number.
Obtaining a fragment of a repair part, such that it contains at least x columns of holes (51), where x=NC+6.
Making holes in the part to be repaired (2) such that there are at least 3 columns of repair holes (52) on either side of the damaged area (3), made such that the distance between the centers of consecutive repair holes (52) is the same as the distance between the centers of the consecutive holes (51).
Attaching said repair part (1) to the part to be repaired (2) by means of riveting.

1. A repair part, characterized in that:
it is made of a composite material,
it is an elongated part comprising two attached portions forming an angle comprised between 60° and 120°, the line joining both portions being substantially straight, and
it comprises a plurality of holes in each portion, arranged in the direction of the line joining both portions.

2. The repair part according to claim 1, characterized in that the angle formed by the two portions is comprised between 85° and 95°.

3. The repair part according to claim 1, characterized in that the holes of each portion are arranged in at least two rows parallel to the direction of the line joining the portions of said repair part.

4. The repair part according to claim 1, characterized in that the holes are arranged in two parallel rows such that the distance between consecutive holes of the same row is substantially identical.

5. The repair part according to claim 1, characterized in that the two parallel rows of holes are arranged such that the line joining the centers of each hole with the consecutive hole in each row and in each column form a right-angle grid layout.

6. The repair part according to claim 5, characterized in that the distance between the centers of two consecutive holes of the same row is between four and six times the diameter of the holes of the repair part.

7. The repair part according to claim 5, characterized in that the distance between rows is between four and six times the diameter of the holes of the repair part.

8. The repair part according to claim 1, characterized in that the two parallel rows of holes are staggered such that the position of the holes in one of the two rows corresponds with the projection of the mid-points between consecutive holes of the other row.

9. The repair part according to claim 8, characterized in that the distance between the centers of two consecutive holes of the same row is between four and eight times the diameter of the holes of the repair part.

10. The repair part according to claim 8, characterized in that the distance between rows is between two and four times the diameter of the holes of the repair part.

11. The repair part according to claim 1, characterized in that the distance between each edge of a portion of the repair part and the line joining the centers of holes of the row of holes closest to said edge of said portion of the part is between two and three times the diameter of the holes of the repair part.

12. A repair method for repairing an elongated part to be repaired, made of a composite material, comprising two attached portions forming an angle between 60° and 120°, the line joining both portions being substantially straight and said part to be repaired comprising a damaged area, the method comprises:
providing a fragment of a repair part according to claim 1, being long enough to cover the damaged area of the part to be repaired, maintaining a margin for fixing the fragment of the repair part to the part to be repaired;
making holes in the part to be repaired on both sides of the damaged area in a longitudinal direction, such that the distance between the centers of consecutive repair holes is the same as the distance between the centers of the consecutive holes of the repair part;
making holes in the part to be repaired in a portion of said part other than in that portion in which the holes were made in the preceding step, such that the distance between the centers of consecutive repair holes is the same as the distance between the centers of the consecutive holes of the repair part; and
attaching the fragment of said repair part to the part to be repaired.

13. The repair method according to claim 12, characterized in that the step of providing a fragment of a repair part comprises:
determining the length LD of the damaged area in the direction of the line joining the portions of said part to be repaired;
calculating the number NC of holes necessary for covering the damaged area of the part to be repaired by the formula NC=LD/DC, rounding up to the next natural number, DC being the distance between two consecutive holes of the same row; and
providing a fragment of the repair part that comprises at least x holes in the same row, where x=NC+6.

14. The repair method according to claim 12, characterized in that substantially the same number of columns of repair holes is made on each side of the damaged area.

15. The repair method according to claim 12, characterized in that the part to be repaired is attached to the repair part by rivets.
